(19) United States
(12) Patent Application Publication
(10) Pub. No.: US 2026/0194777 A1
(43) Pub. Date: Jul. 9, 2026

(54) BACKLIGHT UNIT AND DISPLAY APPARATUS INCLUDING THE SAME

(71) Applicant: SAMSUNG ELECTRONICS CO., LTD., Suwon-si (KR)

(72) Inventors: Chunsoon PARK, Suwon-si (KR); Hyukjun JANG, Suwon-si (KR); Taeyeon KIM, Suwon-si (KR); Sungyeol KIM, Suwon-si (KR)

(73) Assignee: SAMSUNG ELECTRONICS CO., LTD., Suwon-si (KR)

(21) Appl. No.: 19/539,866

(22) Filed: Feb. 13, 2026

Related U.S. Application Data
(63) Continuation of application No. PCT/KR2025/022688, filed on Dec. 24, 2025.

(30) Foreign Application Priority Data
Jan. 3, 2025 (KR) 10-2025-0001143
Mar. 7, 2025 (KR) 10-2025-0030136
Apr. 22, 2025 (KR) 10-2025-0052654

(51) Int. Cl. G02F 1/13357; F21V 8/00

(52) U.S. Cl. CPC G02F 1/133605; G02B 6/0068

(57) ABSTRACT

Provided is a display apparatus including: a display panel; and a backlight unit configured to provide light to the display panel; wherein the backlight unit includes: a substrate including a first feeding pad, a second feeding pad, and a common pad; a first light-emitting diode connected to the first feeding pad and the common pad; a second light-emitting diode spaced apart from the first light-emitting diode in a first direction and connected to the second feeding pad and the common pad; and an optical dome on the first light-emitting diode and the second light-emitting diode, and wherein a length of a bottom surface of the optical dome in the first direction is different from a length of the bottom surface in a second direction perpendicular to the first direction.

### CROSS-REFERENCE TO RELATED APPLICATIONS

This application is a by-pass continuation of International Application No. PCT/KR2025/022688, filed on December 24, 2025, which is based on and claims priority to: Korean Patent Application No. 10-2025-0001143, filed in the Korean Intellectual Property Office on January 3, 2025; Korean Patent Application No. 10-2025-0030136, filed in the Korean Intellectual Property Office on March 7, 2025; and Korean Patent Application No. 10-2025-0052654, filed in the Korean Intellectual Property Office on April 22, 2025, the disclosures of which are incorporated by reference herein in their entireties.

### BACKGROUND

### 1. Field

The present disclosure relates to a display apparatus including a backlight unit.

### 2. Description of Related Art

A display apparatus is a type of output device that converts acquired or stored electrical information into visual information to be presented to a user.

Display apparatuses may include a monitor device connected to a personal computer, a server computer, or the like, a portable computer device, a navigation terminal device, a general television device, an Internet protocol television (IPTV) device, a portable terminal device such as a smart phone, a tablet PC, a personal digital assistant (PDA), a cellular phone, or the like, and various display apparatuses used to reproduce an image such as an advertisement or a movie in an industrial field.

A display apparatus may include a display panel and a backlight unit that provides light toward the display panel. The backlight unit may include a plurality of light sources for independently emitting light.

There is a growing demand for display apparatuses with higher luminance, and in order to realize this, a backlight unit may be designed to include an increased number of light sources.

However, since the size of a substrate on which the light sources are mounted is limited, there is a physical limit to simply increasing the number of light sources.

In addition, as the number of light sources mounted on the substrate increases, the interval between the light sources on the substrate decreases, which may complicate the design for wiring between the light sources.

### SUMMARY

Provided is a backlight unit including an optical dome configured to cover a plurality of light sources arranged adjacent to each other, and a display apparatus including the same.

Further provided is a backlight unit in which a mura effect occurring between a plurality of optical domes is reduced by changing the shape of each of the plurality of optical domes, and a display apparatus including the same.

Further provided is a backlight unit with improved light uniformity and enhanced visual quality by reducing mura, and a display apparatus including the same.

Further provided is a backlight unit having improved luminance by increasing the number of light sources, and a display apparatus including the same.

The technical objectives of the present disclosure are not limited to the above, and other objectives that are not described above will be clearly understood by those skilled in the art from the above detailed description.

According to an aspect of the disclosure, a display apparatus includes: a display panel; and a backlight unit configured to provide light to the display panel; wherein the backlight unit includes: a substrate including a first feeding pad, a second feeding pad, and a common pad; a first light-emitting diode connected to the first feeding pad and the common pad; a second light-emitting diode spaced apart from the first light-emitting diode in a first direction and connected to the second feeding pad and the common pad; and an optical dome on the first light-emitting diode and the second light-emitting diode, and wherein a length of a bottom surface of the optical dome in the first direction is different from a length of the bottom surface in a second direction perpendicular to the first direction.

The first feeding pad may be connected to an anode of the first light-emitting diode, the second feeding pad may be connected to a cathode of the second light-emitting diode, and the common pad may be connected to a cathode of the first light-emitting diode and an anode of the second light-emitting diode.

The cathode of the first light-emitting diode and the anode of the second light-emitting diode may be spaced apart in the first direction, and the common pad may extend in the first direction and may be connected to the cathode of the first light-emitting diode and the anode of the second light-emitting diode.

The length of the bottom surface in the first direction may be longer than the length of the bottom surface in the second direction.

A long side of the first light-emitting diode and a long side of the second light-emitting diode may be parallel to each other and may be spaced apart in the first direction. A maximum length of the optical dome in the first direction may be a major axis of the optical dome. A maximum length of the optical dome in the second direction may be a minor axis of the optical dome. The major axis may be parallel to a short side of the first light-emitting diode and a short side of the second light-emitting diode, and the minor axis may be parallel to a long side of the first light-emitting diode and a long side of the second light-emitting diode.

A ratio of the minor axis to the major axis may be greater than or equal to 0.8 and is less than or equal to 0.9.

A separation distance in the first direction between the long side of the first light-emitting diode and the long side of the second light-emitting diode may be greater than or equal to 250 μm and may be less than or equal to 350 μm.

A maximum separation distance between the substrate and the optical dome in a third direction perpendicular to the first direction and the second direction may be a height of the optical dome, and a ratio of the height to the major axis may be greater than or equal to 0.245 and may be less than or equal to 0.305.

A maximum separation distance between the substrate and the optical dome in a third direction perpendicular to the first direction and the second direction may be h. A separation distance in the first direction between the long side of the first light-emitting diode and the long side of the second light-emitting diode may be d. A length of the major axis may be L1. A length of the minor axis may be L2, and 0.245(1 + d/L2) ≤ h/L2 ≤ 0.305(1 + d/L2).

According to an aspect of the disclosure, a method of manufacturing the display apparatus of claim 1 includes: forming the optical dome by dispensing a liquid resin at two points spaced apart in the first direction.

The first light-emitting diode and the second light-emitting diode may be connected in series.

The display apparatus may further include: a reflective sheet on the substrate, the reflective sheet including a plurality of holes, wherein the first light-emitting diode, the second light-emitting diode, and the optical dome are inside a hole among the plurality of holes.

The first feeding pad may be connected to an end of a first feeding line extending from outside to inside the hole, the second feeding pad may be connected to an end of a second feeding line extending from outside to inside the hole, and both ends of the common pad may be inside the hole.

The display apparatus may further include: a protective layer between the substrate and the reflective sheet. The protective layer may be on the substrate, and the protective layer may include: a first window exposing at least a portion of the first feeding pad and a first portion of the common pad; and a second window exposing at least a portion of the second feeding pad and a second portion of the common pad.

According to an aspect of the disclosure, a display apparatus includes: a display panel; and a backlight unit configured to provide light to the display panel; wherein the backlight unit includes: a substrate; and a plurality of light sources on the substrate, wherein each light source of the plurality of light sources includes: a first feeding pad, a second feeding pad, and a common pad; a first light-emitting diode connected to the first feeding pad and the common pad; a second light-emitting diode spaced apart from the first light-emitting diode in a first direction and connected to the second feeding pad and the common pad; and an optical dome on the first light-emitting diode and the second light-emitting diode, wherein a length in the first direction of a bottom surface of the optical dome of each of the plurality of light sources is different from a length in a second direction of the bottom surface of the optical dome of each of the plurality of light sources, and wherein the second direction is perpendicular to the first direction.

The display apparatus may further include: a reflective sheet on the substrate, the reflective sheet including a plurality of holes, wherein each of the plurality of light sources is inside a respective hole of the plurality of holes.

For each of the plurality of light sources: the first feeding pad is connected to an end of a first feeding line extending from outside to inside of the hole in which the light source is located, among the plurality of holes, the second feeding pad is connected to an end of a second feeding line extending from outside to inside of the hole in which the light source is located, among the plurality of holes, and both ends of the common pad are inside of the hole in which the light source is located, among the plurality of holes.

The display apparatus may further include a protective layer between the substrate and the reflective sheet. The protective layer may cover the substrate, and the protective layer may include: a plurality of first windows each exposing at least a portion of the first feeding pad and a first portion of the common pad of a respective light source among the plurality of light sources; and a plurality of second windows each exposing at least a portion of the second feeding pad and a second portion of the common pad of a respective light source among the plurality of light sources.

According to an aspect of the disclosure, a backlight unit configured to provide light to a display panel includes: a first light-emitting diode; a second light-emitting diode spaced apart from the first light-emitting diode in a first direction; and an optical dome on the first light-emitting diode and the second light-emitting diode, wherein a length of a bottom surface of the optical dome in the first direction is different from a length of the bottom surface in a second direction perpendicular to the first direction.

A long side of the first light-emitting diode and a long side of the second light-emitting diode may be parallel to each other and may be spaced apart in the first direction, a maximum length of the optical dome in the first direction may be a major axis of the optical dome, a maximum length of the optical dome in the second direction may be a minor axis of the optical dome, the major axis may be parallel to a short side of the first light-emitting diode and a short side of the second light-emitting diode, and the minor axis may be parallel to a long side of the first light-emitting diode and a long side of the second light-emitting diode.

### BRIEF DESCRIPTION OF THE DRAWINGS

The above and other aspects and features of certain embodiments of the present disclosure will be more apparent from the following description taken in conjunction with the accompanying drawings, in which:

FIG. 1 illustrates a display apparatus according to one or more embodiments;

FIG. 2 is an exploded view of a display apparatus according to one or more embodiments;

FIG. 3 is a cross-sectional view of a liquid crystal panel of a display apparatus according to one or more embodiments;

FIG. 4 is an exploded view of a backlight unit of a display apparatus according to one or more embodiments;

FIG. 5 is an enlarged view of a light source of the backlight unit according to one or more embodiments;

FIG. 6 is an exploded view of the light source shown in FIG. 5;

FIG. 7 is a plan view of the light source shown in FIG. 5;

FIG. 8 is a cross-sectional view taken along line A-A’ of FIG. 5; and

FIG. 9 is a cross-sectional view taken along line B-B’ of FIG. 5.

### DETAILED DESCRIPTION

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the disclosure, and do not exclude the presence or addition of one or more other features, numbers, steps, operations, elements, parts, or combinations thereof.

It will be understood that, although the terms first, second, and the like. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

The terms “front,” “rear,” “left,” and “right” used in the following description are defined based on the drawings, and the shapes and positions of the respective components are not limited by these terms. For example, the terms “front” and “rear” may refer to the +X direction and the –X direction, respectively, as shown in the drawings. The terms “upper” and “lower” may refer to the +Z direction and the –Z direction, respectively, as shown in the drawings. The terms “left direction” and “right direction” may refer to the +Y direction and the –Y direction, respectively, as shown in the drawings. The term “vertical direction” may refer to the Z direction shown in the drawings, and the term “horizontal direction” may refer to the Y direction shown in the drawings. However, in some drawings, the +X direction may be referred to as “upper,” and the –X direction may be referred to as “lower.”

Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection may include “connection via a wireless communication network”.

Throughout the description, when a member is “on” another member, this includes not only a configuration where the member is in contact with the other member, but also a configuration where there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereinafter, embodiments according to the present disclosure will be described in detail with reference to the accompanying drawings

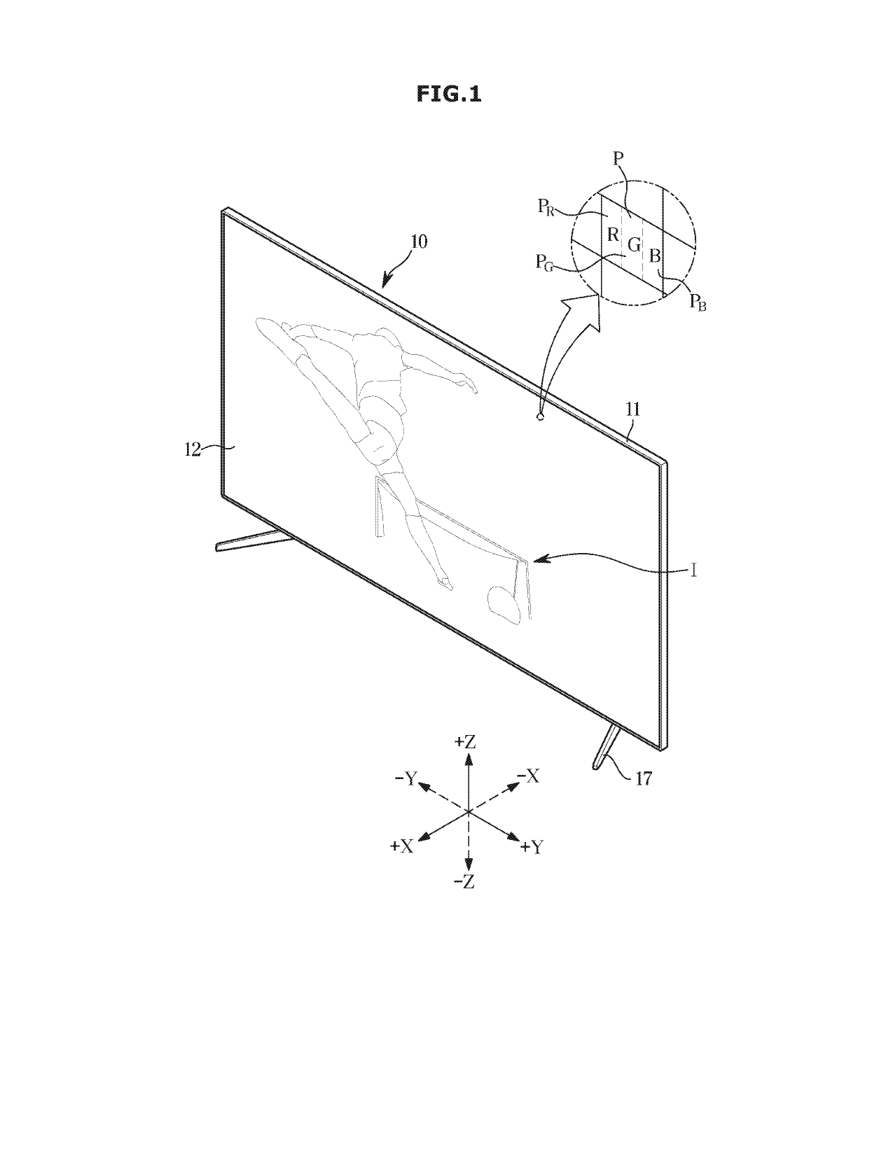

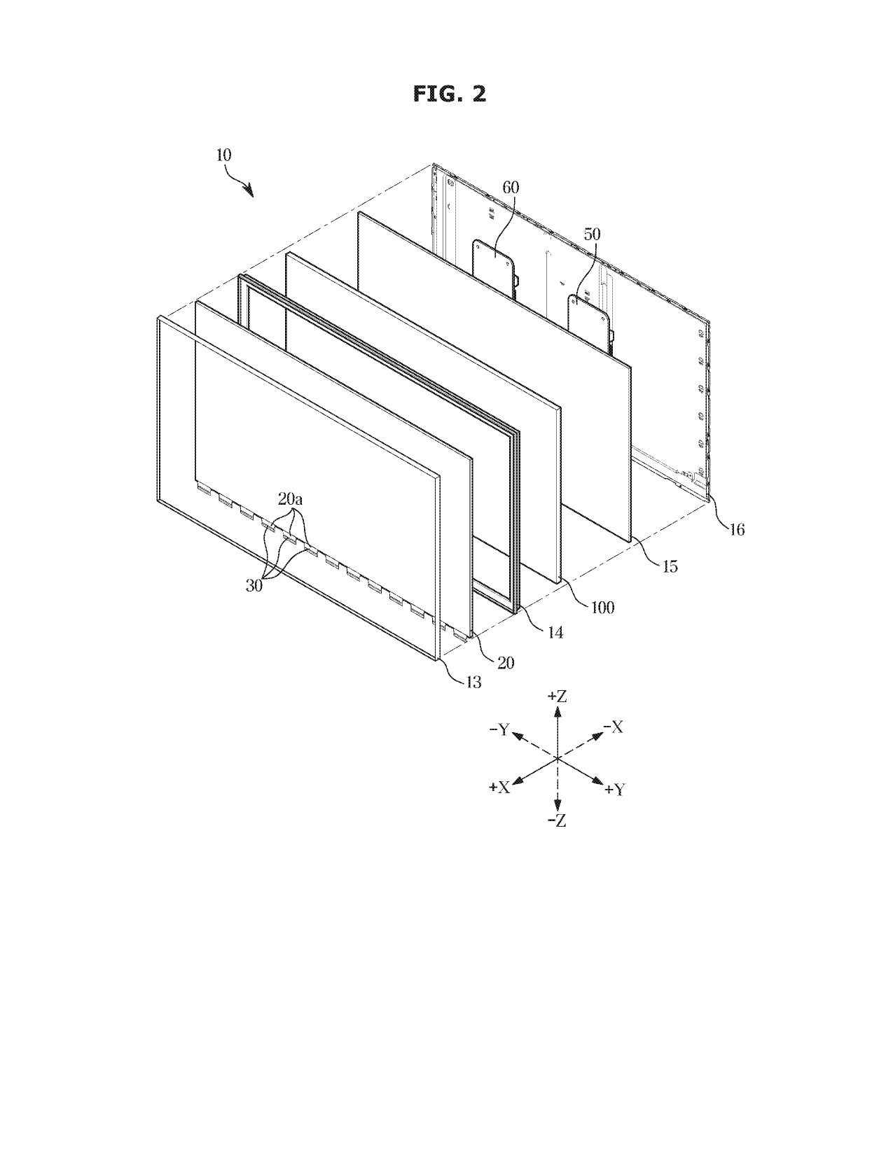

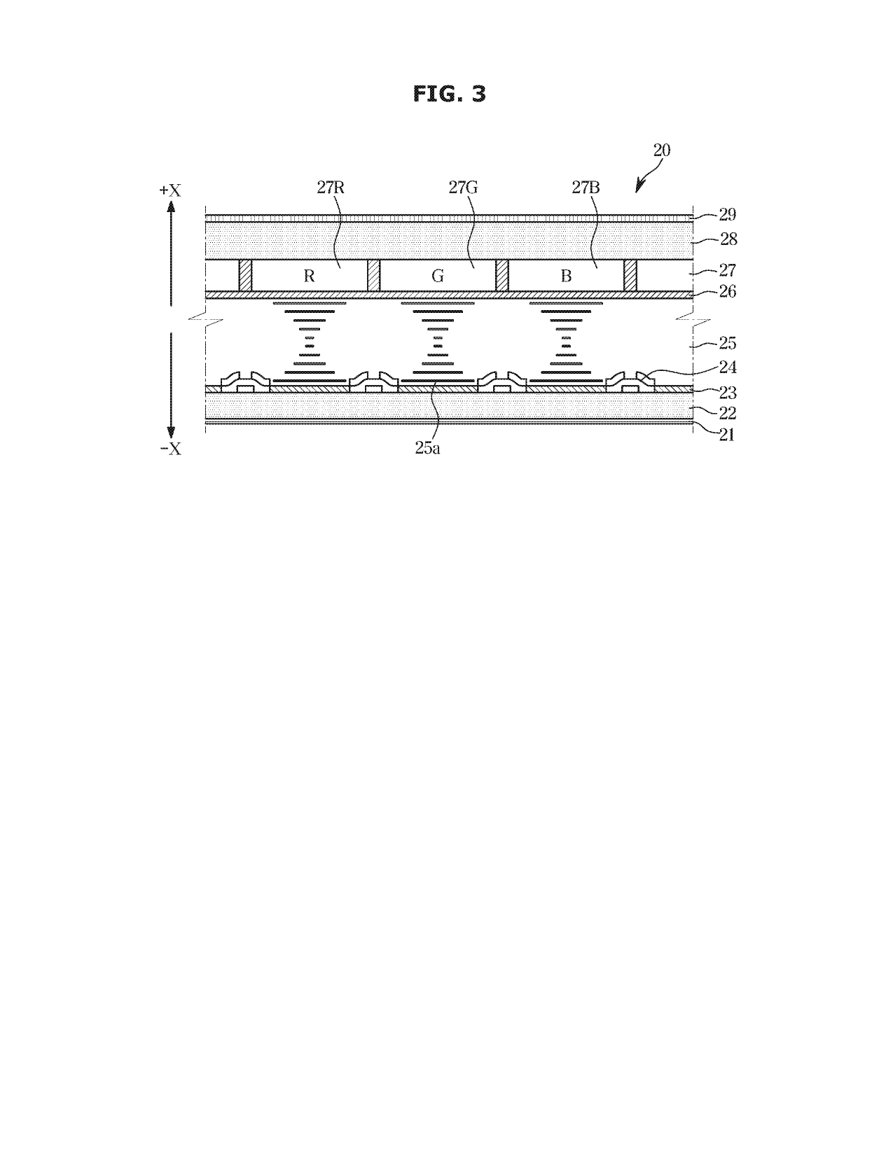

FIG. 1 illustrates a display apparatus according to one or more embodiments. FIG. 2 is an exploded view of a display apparatus according to one or more embodiments. FIG. 3 is a cross-sectional view of a liquid crystal panel of a display apparatus according to one or more embodiments.

Referring to FIG. 1, the display apparatus 10 is a device capable of processing an image signal received from the outside and visually displaying the processed image. Hereinafter, an example in which the display apparatus 10 is a television (TV) is described, but the present disclosure is not limited thereto. For example, the display apparatus 10 may be implemented in various forms such as a monitor, a portable multimedia device, a portable communication device, and the like, and the forms of the display apparatus 10 are not limited in the case of a device configured to visually display an image.

In addition, the display apparatus 10 may be a large format display (LFD) installed at the outside such as on a rooftop of a building or at a bus stop. Here, the outside is not necessarily limited to the outdoors, and the display apparatus 10 according to one or more embodiments may be installed in a place in which a large number of people may enter and exit even in the case of indoors such as a subway station, a shopping mall, a movie theater, a company, a store, or the like.

The display apparatus 10 may receive content data including video data and audio data from various content sources, and output a video and an audio respectively corresponding to the video data and the audio data. For example, the display apparatus 10 may receive content data through a broadcast reception antenna or a wired cable, receive content data from a content reproduction device, or receive content data from a content providing server of a content provider.

As shown in FIG. 1, the display apparatus 10 includes a main body 11, a screen 12 configured to display an image I, and a support 17 provided under the main body 11 to support the main body 11.

The main body 11 forms an appearance of the display apparatus 10, and components configured to cause the display apparatus 10 to display the image I or perform various functions may be provided in the main body 11. The main body 11 shown in FIG. 1 has a flat plate shape, but the shape of the main body 11 is not limited to the case shown in FIG. 1. For example, the main body 11 may have a curved plate shape.

The screen 12 may be formed on a front surface of the main body 11, and may display the image I. For example, the screen 12 may display a still image or a video. Further, the screen 12 may display a two-dimensional flat image or a three-dimensional stereoscopic image using the parallax of a user’s eyes.

A plurality of pixels P are formed on the screen 12, and the image I displayed on the screen 12 may be formed by light emitted from each of the plurality of pixels P. For example, the image I may be formed on the screen 12 by combining the light emitted by the plurality of pixels P like a mosaic.

Each of the plurality of pixels P may emit light of various brightness and colors. For example, each of the plurality of pixels P includes a self-luminous light-emitting panel (for example, a light-emitting diode panel) capable of directly emitting light, or a non- self-luminous light-emitting panel capable of allowing light emitted by a backlight unit or the like to pass therethrough or blocking the light (for example, a liquid crystal panel).

In order to emit light of various colors, each of the plurality of pixels P may include sub-pixels PR, PG, and PB.

The sub-pixels PR, PG, and PB may include a red sub-pixel PR capable of emitting red light, a green sub-pixel PG capable of emitting green light, and a blue sub-pixel PB capable of emitting blue light. For example, the red light may represent light of a wavelength from approximately 620 nm (nanometer, billionths of a meter) to 750 nm, the green light may represent light of a wavelength from approximately 495 nm to 570 nm, and the blue light may represent light of a wavelength from approximately 450 nm to 495 nm.

The light of various brightness and colors may be emitted from each of the plurality of pixels P by combination of the red light of the red sub-pixel PR, the green light of the green sub-pixel PG, and the blue light of the blue sub-pixel PB.

As shown in FIG. 2, various components configured to generate the image I on a screen 12 may be provided in the main body 11.

For example, the main body 11 may be provided at an inside thereof with a backlight unit 100 which is a surface light source, a liquid crystal panel 20 configured to block the light emitted from the backlight unit 100 or allow the light to pass therethrough, a control assembly

50 configured to control operations of the backlight unit 100 and the liquid crystal panel 20, and a power assembly 60 configured to supply power to the backlight unit 100 and the liquid crystal panel 20. Further, the main body 11 includes a bezel 13, a frame middle mold 14, a bottom chassis 15, and a back cover 16 configured to support and fix the liquid crystal panel 20, the backlight unit 100, the control assembly 50, and the power assembly 60.

The backlight unit 100 may include a point light source configured to emit monochromatic light or white light, and may refract, reflect, and scatter the light to convert light emitted from the point light source to uniform surface light. For example, the backlight unit 100 may include a plurality of light sources configured to emit the monochromatic light or the white light, a diffuser plate configured to diffuse light incident from the plurality of light sources, a reflective sheet configured to reflect light emitted from the plurality of light sources 111 and a back surface of the diffuser plate, and an optical sheet configured to refract and scatter light emitted from a front surface of the diffuser plate.

Like the above, the backlight unit 100 may emit the uniform surface light toward the front by refracting, reflecting, and scattering the light emitted from the light sources.

Configurations of the backlight unit 100 will be described below in more detail.

The liquid crystal panel 20 may be provided in front of the backlight unit 100. The liquid crystal panel 20 may block the light emitted from the backlight unit 100 or allow the light to pass therethrough to form the image I.

A front surface of the liquid crystal panel 20 may form the screen 12 of the above-described display apparatus 10, and the liquid crystal panel 20 may form the plurality of pixels P. In the liquid crystal panel 20, the plurality of pixels P may each independently block the light of the backlight unit 100 or allow the light to pass therethrough, and the light passing through the plurality of pixels P may form the image I displayed on the screen 12.

For example, as shown in FIG. 3, the liquid crystal panel 20 may include a first polarization film 21, a first transparent substrate 22, a pixel electrode 23, a thin film transistor 24, a liquid crystal layer 25, a common electrode 26, a color filter 27, a second transparent substrate 28, and a second polarization film 29.

The first transparent substrate 22 and the second transparent substrate 28 may fix and support the pixel electrode 23, the thin film transistor 24, the liquid crystal layer 25, the common electrode 26, and the color filter 27. The first and second transparent substrates 22 and 28 may be composed of tempered glass or a transparent resin.

The first polarization film 21 and the second polarization film 29 may be respectively provided at outer sides of the first and second transparent substrates 22 and 28.

Each of the first polarization film 21 and the second polarization film 29 may allow specific light to pass therethrough and block other light. For example, the first polarization film 21 allows light having a magnetic field which oscillates in a first direction to pass therethrough and blocks other light. Further, the second polarization film 29 allows light having a magnetic field which oscillates in a second direction to pass therethrough and blocks other light. In this case, the first direction and the second direction may be orthogonal to each other. Accordingly, a polarization direction of the light passing through the first polarization film 21 and an oscillation direction of the light passing through the second polarization film 29 are orthogonal to each other. As a result, light may not pass through the first polarization film 21 and the second polarization film 29 at the same time.

The color filter 27 may be provided at an inner side of the second transparent substrate 28.

The color filter 27 may include, for example, a red filter 27R configured to allow red light to pass therethrough, a green filter 27G configured to allow green light to pass therethrough, and a blue filter 27B configured to allow blue light to pass therethrough, and the red filter 27R, the green filter 27G, and the blue filter 27B may be disposed in parallel. A region in which the color filter 27 is formed corresponds to the above-described pixel P. A region in which the red filter 27R is formed corresponds to the red sub-pixel PR, a region in which the green filter 27G is formed corresponds to the green sub-pixel PG, and a region in which the blue filter 27B is formed corresponds to the blue sub-pixel PB.

The pixel electrode 23 may be provided at an inner side of the first transparent substrate 22, and the common electrode 26 may be provided at the inner side of the second transparent substrate 28.

The pixel electrode 23 and the common electrode 26 may be composed of a metal material that conducts electricity, and may generate an electric field for changing the arrangement of liquid crystal molecules 25a constituting the liquid crystal layer 25 to be described below.

The pixel electrode 23 and the common electrode 26 may be composed of a transparent material, and may allow light incident from the outside to pass therethrough. For example, the pixel electrode 23 and the common electrode 26 may be composed of indium tin oxide (ITO), indium zinc oxide (IZO), a silver nanowire (Ag nanowire), a carbon nanotube (CNT), graphene, poly3,4-ethylenedioxythiophene) (PEDOT), or the like.

The thin film transistor (TFT) 24 is provided at the inner side of the second transparent substrate 22.

The thin film transistor 24 may allow a current flowing through the pixel electrode 23 to pass therethrough or block the current. For example, an electric field may be formed or removed between the pixel electrode 23 and the common electrode 26 according to turn-on (closed) or turn-off (open) of the thin film transistor 24.

The thin film transistor 24 may be composed of poly-silicon, and may be formed by semiconductor processes such as a lithography process, a deposition process, an ion implantation process, and the like.

The liquid crystal layer 25 is formed between the pixel electrode 23 and the common electrode 26, and is filled with the liquid crystal molecules 25a.

A liquid crystal indicates an intermediate state between a solid (crystal) and a liquid. Most of the liquid crystal materials are organic compounds, their molecular shape is a long and thin rod, and may have a crystal form in which the arrangement of the molecules is irregular in any direction, but is regular in another direction. As a result, the liquid crystal has both fluidity of the liquid and optical anisotropy of the crystal (solid).

Further, the liquid crystal also exhibits optical properties according to a change in electric field. For example, in the liquid crystal, the direction of the arrangement of molecules constituting the liquid crystal may be changed according to the change in electric field. When the electric field is generated in the liquid crystal layer 25, the liquid crystal molecules 25a of the liquid crystal layer 25 are arranged according to the direction of the electric field, and when the electric field is not generated in the liquid crystal layer 25, the liquid crystal molecules 25a may be irregularly arranged or may be arranged along an alignment layer. As a result, the optical properties of the liquid crystal layer 25 may be changed according to the presence or absence of the electric field passing through the liquid crystal layer 25.

A cable 20a configured to transmit image data to the liquid crystal panel 20, and a display driver integrated circuit 30 (DDI, hereinafter, referred to as a “driver IC”) configured to process digital image data and output an analog image signal are provided at one side of the liquid crystal panel 20.

The cable 20a may electrically connect the control assembly 50/power assembly 60 and the driver IC 30 and may also electrically connect the driver IC 30 and the liquid crystal panel 20. The cable 20a may include a flexible flat cable, a film cable, or the like, which may be bent.

The driver IC 30 receives the image data and power from the control assembly 50/power assembly 60 through the cable 20a and supplies the image data and a driving current to the liquid crystal panel 20 through the cable 20a.

Further, the cable 20a and the driver IC 30 may be integrally implemented as a film cable, a chip on film (COF), a tape carrier package (TCP), or the like. In other words, the driver IC 30 may be disposed on the cable 20a. However, the present disclosure is not limited thereto, and the driver IC 30 may be disposed on the liquid crystal panel 20.

The control assembly 50 may include a control circuit configured to control the operations of the liquid crystal panel 20 and the backlight unit 100. The control circuit may process image data received from an external content source, transmit the image data to the liquid crystal panel 20, and transmit dimming data to the backlight unit 100.

The power assembly 60 may supply power to the liquid crystal panel 20 and the backlight unit 100 so that the backlight unit 100 outputs surface light and the liquid crystal panel 20 blocks the light from the backlight unit 100 or allows the light to pass therethrough.

The control assembly 50 and the power assembly 60 may be implemented as a printed circuit board and various circuits mounted on the printed circuit board. For example, the power circuit may include a capacitor, a coil, a resistor, a processor, and the like, and a power circuit board on which the above parts are mounted. Further, the control circuit may include a memory, a processor, and a control circuit board on which the above parts are mounted.

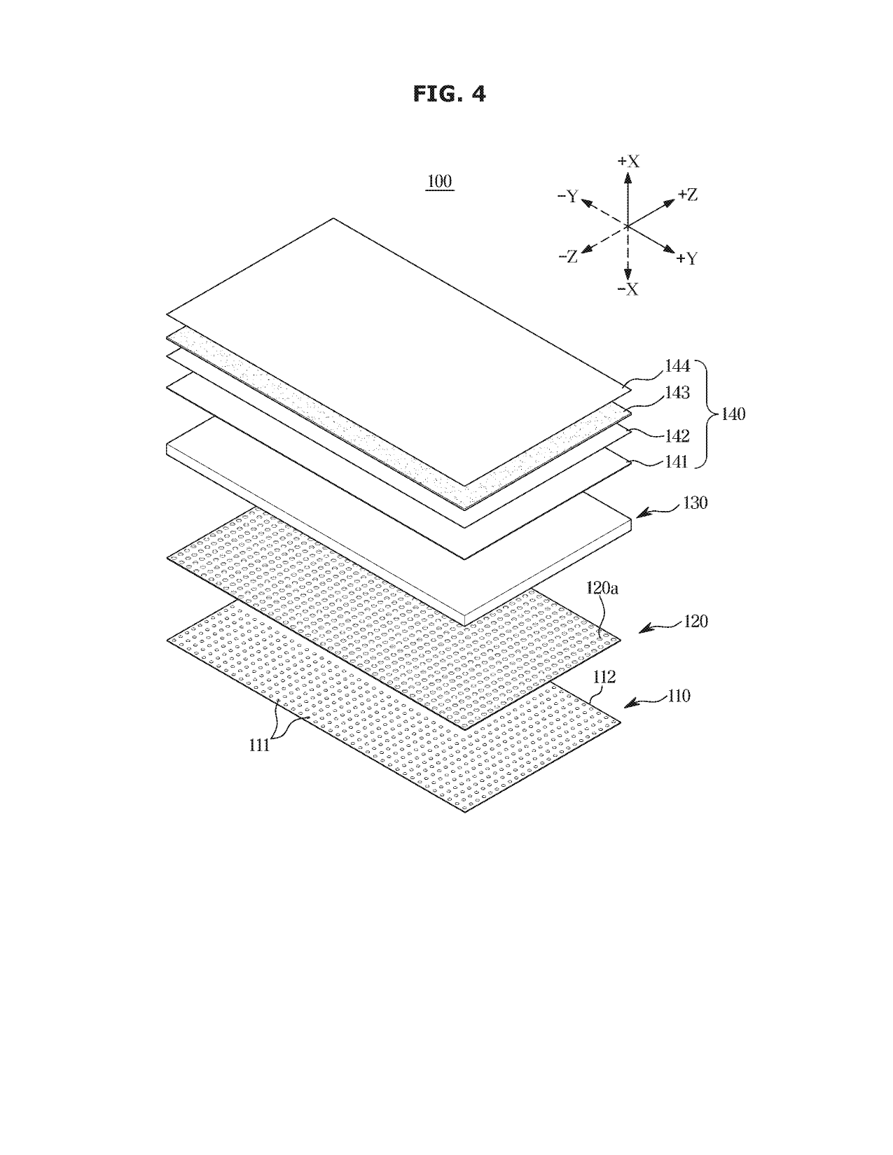

FIG. 4 is an exploded view of a backlight unit of a display apparatus according to one or more embodiments.

The backlight unit 100 includes a light source module 110 configured to generate light, the reflective sheet 120 configured to reflect the light, the diffuser plate 130 configured to uniformly diffuse the light, and the optical sheet 140 configured to improve the luminance of the emitted light.

The light source module 110 may include the plurality of light sources 111 configured to emit light and a substrate 112 configured to support and fix the plurality of light sources 111.

The plurality of light sources 111 may be disposed in a predetermined pattern so that light may be emitted with uniform luminance. The plurality of light sources 111 may be disposed so that distances between one light source and light sources adjacent thereto may become the same.

For example, as shown in FIG. 4, the plurality of light sources 111 may be disposed in rows and columns. Accordingly, a plurality of light sources may be disposed so that that a substantially square may be formed by four adjacent light sources. Further, any one light source may be disposed adjacent to the four light sources, and distances between the one light source and the four light sources adjacent thereto may be approximately the same.

As another example, the plurality of light sources may be disposed in a plurality of rows, and a light source belonging to each row may be disposed at a center between two light sources belonging to adjacent rows. Accordingly, the plurality of light sources may be disposed so that an approximately equilateral triangle may be formed by three adjacent light sources. In this case, one light source may be disposed adjacent to six light sources, and distances between the one light source and the six light sources adjacent thereto may be approximately the same.

However, the pattern in which the plurality of light sources 111 are disposed is not limited to the above-described pattern, and the plurality of light sources 111 may be disposed in various patterns so that light may be emitted with uniform luminance.

The light source 111 may employ an element capable of emitting monochromatic light (light of a specific wavelength, for example, blue light) or white light (for example, a mixture of red light, green light, and blue light) in various directions when power is supplied. For example, the light source 111 may include a light-emitting diode (LED).

The substrate 112 may fix the plurality of light sources 111 so that positions of the light sources 111 are not changed. Further, the substrate 112 may supply power for emitting light by the light sources 111 to each light source 111.

The substrate 112 may be composed of a synthetic resin or tempered glass or a printed circuit board (PCB) formed with a conductive feeding line configured to fix the plurality of light sources 111 and supply the power to the light sources 111.

The reflective sheet 120 may reflect the light emitted from the plurality of light sources 111 in a frontward direction or in a direction close to the frontward direction.

A plurality of through holes 120a may be formed in the reflective sheet 120 at positions respectively corresponding to the plurality of light sources 111 of the light source module 110. Further, the light sources 111 of the light source module 110 may pass through the through holes 120a and protrude in front of the reflective sheet 120.

For example, in a process of assembling the reflective sheet 120 and the light source module 110, the plurality of light sources 111 of the light source module 110 may be inserted into the plurality of through holes 120a formed in the reflective sheet 120. The substrate 112 of the light source module 110 is located behind the reflective sheet 120, but the plurality of light sources 111 of the light source module 110 may be located in front of the reflective sheet 120. The plurality of light sources 111 may emit light from the front of the reflective sheet 120.

The plurality of light sources 111 may emit light in various directions in front of the reflective sheet 120. The light may be emitted toward the diffuser plate 130 from the light sources 111 as well as toward the reflective sheet 120 from the light sources 111, and the reflective sheet 120 may reflect the light emitted toward the reflective sheet 120 toward the diffuser plate 130.

The light emitted from the light sources 111 passes through various objects such as the diffuser plate 130, the optical sheet 140, and the like. When the light passes through the diffuser plate 130 and the optical sheet 140, some of the incident light is reflected from the surfaces of the diffuser plate 130 and the optical sheet 140. The reflective sheet 120 may reflect the light reflected by the diffuser plate 130 and the optical sheet 140.

The diffuser plate 130 may be provided in front of the light source module 110 and the reflective sheet 120, and may uniformly distribute the light emitted from the light sources 111 of the light source module 110.

The diffuser plate 130 may diffuse the light emitted from the plurality of light sources 111 in the diffuser plate 130 to remove the luminance non-uniformity caused by the plurality of light sources 111 arranged to be spaced apart from each other. In other words, the diffuser plate 130 may uniformly emit the non-uniform light from the plurality of light sources 111 to the front.

The optical sheet 140 may include various sheets for improving luminance and luminance uniformity. For example, the optical sheet 140 may include a diffuser sheet 141, a first prism sheet 142, a second prism sheet 143, a reflective polarization sheet 144, and the like. However, the present disclosure is not limited thereto. The optical sheet 140 may include at least one of a diffuser sheet 141, a first prism sheet 142, a second prism sheet 143, and a reflective polarization sheet 144.

The diffuser sheet 141 may diffuse light for luminance uniformity. The light emitted from the light source 111 may be diffused by the diffuser plate 130 and may be diffused again by the diffuser sheet 141 included in the optical sheet 140.

The first and second prism sheets 142 and 143 may increase luminance by focusing the light diffused by the diffuser sheet 141. The first and second prism sheets 142 and 143 may include a prism pattern having a triangular prism shape, and a plurality of the prism patterns are arranged to be adjacent to each other to form a plurality of bands.

The reflective polarization sheet 144 is a type of polarization film, and may transmit some of the incident light to improve luminance and reflect the remaining light. For example, polarized light in the same direction as a predetermined polarization direction of the reflective polarization sheet 144 may be transmitted, and polarized light in a direction different from the polarization direction of the reflective polarization sheet 144 may be reflected. Further, the light reflected by the reflective polarization sheet 144 may be recycled in the backlight unit 100, and the luminance of the display apparatus 10 may be improved by such light recycling.

The optical sheet 140 is not limited to the sheet or film shown in FIG. 4, and may include more various sheets or films, such as a protection sheet and the like.

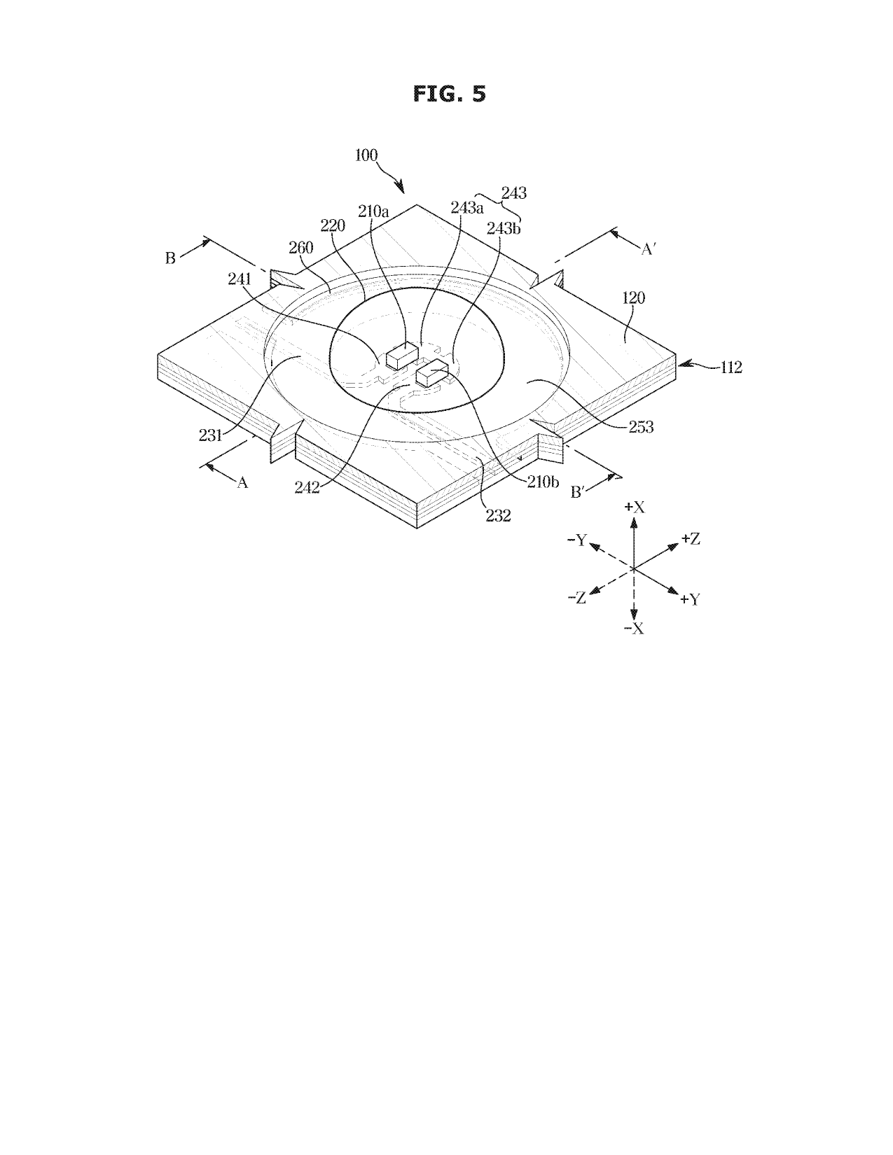

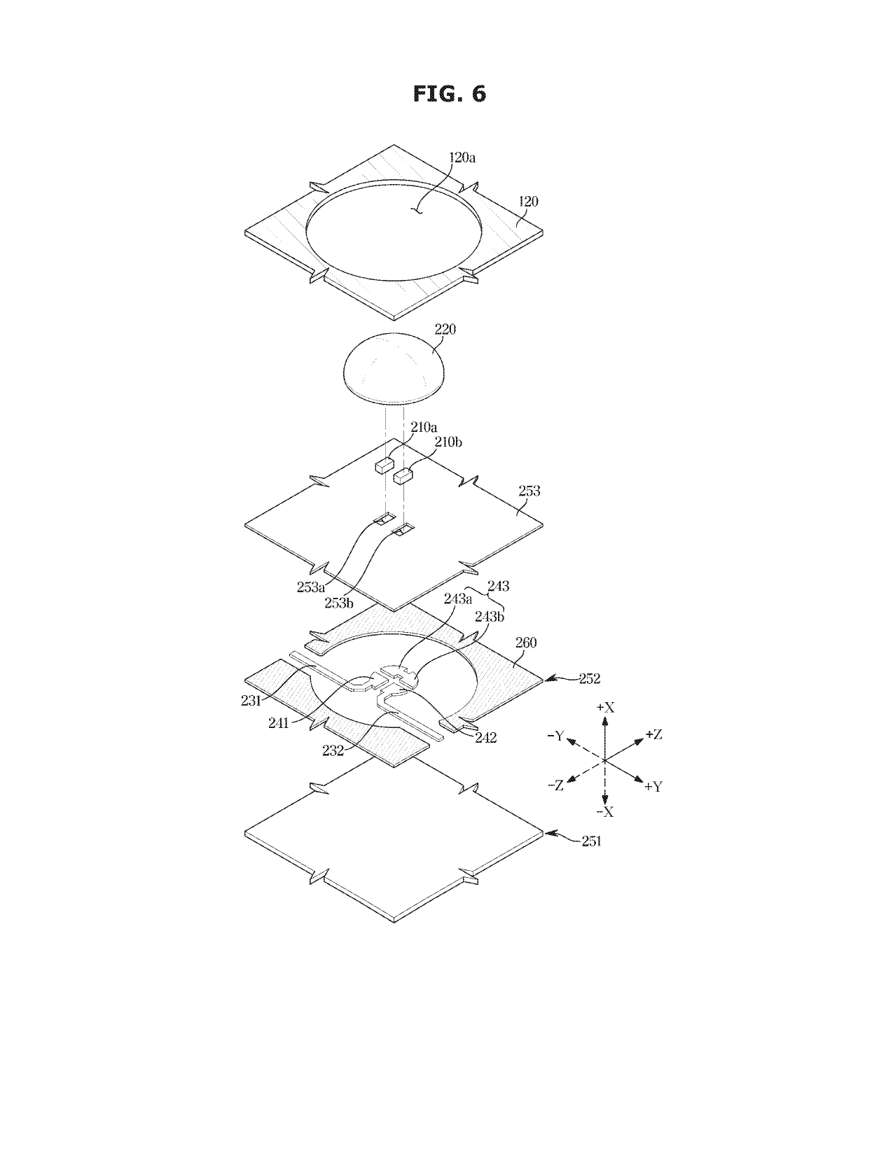

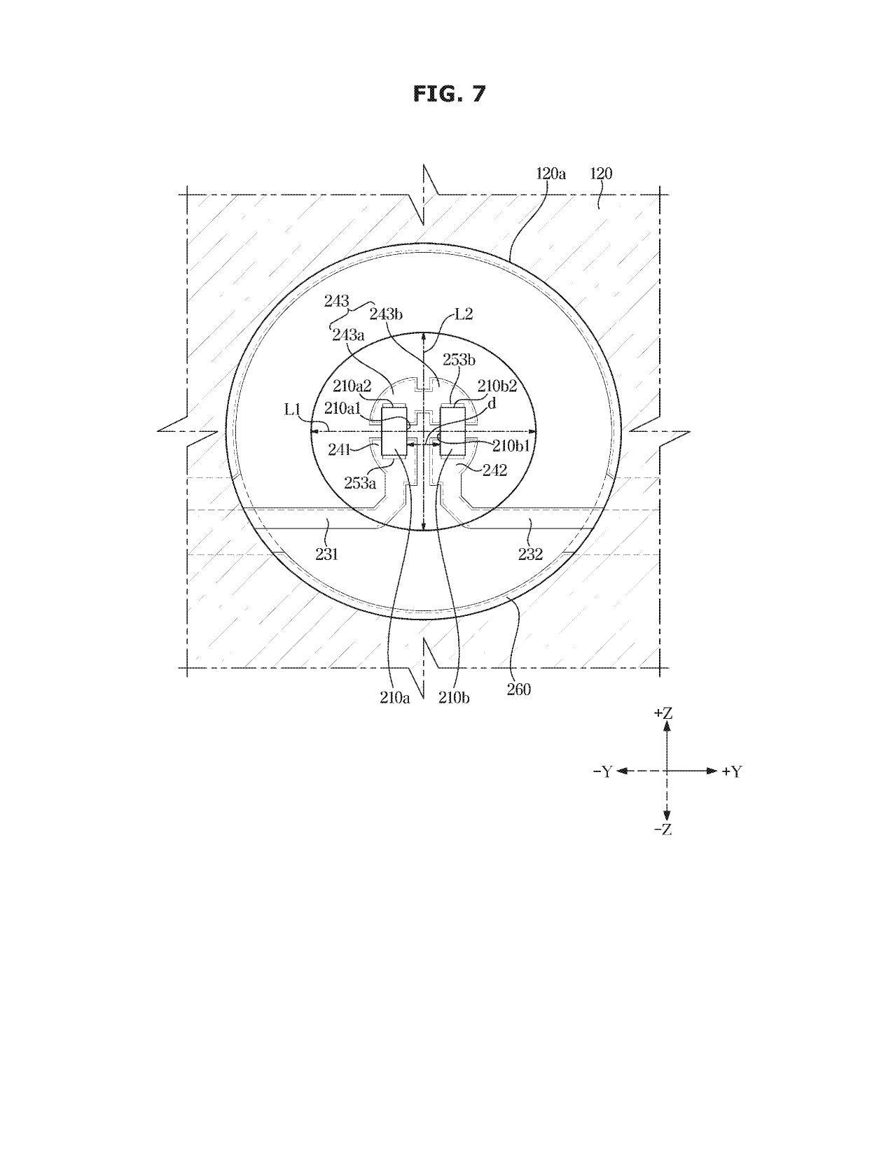

FIG. 5 is an enlarged view of a light source of the backlight unit according to one or more embodiments. FIG. 6 is an exploded view of the light source shown in FIG. 5. FIG. 7 is a plan view of the light source shown in FIG. 5.

Referring to FIG. 5, the backlight unit 100 includes the plurality of light sources 111. The plurality of light sources 111 may include an electrical/mechanical structure located in a region defined by the through hole 120a of the reflective sheet 120.

According to the disclosure, each of the plurality of light sources 111 may include a plurality of light-emitting diodes 210a and 210b, and an optical dome 220 configured to cover the plurality of light-emitting diodes 210a and 210b.

To improve the uniformity of surface light emitted by the backlight unit 100 and to enhance the contrast ratio through local dimming, the number of light sources 111 may be increased. As a result, the region available to be occupied by each of the plurality of light sources 111 may become narrower.

In order to reduce the area of the region occupied by each of the plurality of light sources 111, each of the plurality of light sources 111 may include a plurality of light-emitting diodes 210a and 210b. For example, each of the plurality of light sources 111 may include a first light-emitting diode 210a and a second light-emitting diode 210b.

The first light-emitting diode 210a and the second light-emitting diode 210b may be directly attached to the substrate 112 in a chip on board (COB) manner. The light source 111 may include the first light-emitting diode 210a and the second light-emitting diode 210b of which a light-emitting diode chip or a light-emitting diode die is directly attached to the substrate 112 without separate packaging.

The substrate 112 may be provided with a first feeding line 231, a second feeding line 232, a first feeding pad 241, a second feeding pad 242, and a common pad 243 for supplying power to the first light-emitting diode 210a and the second light-emitting diode 210b.

The first feeding line 231, the second feeding line 232, the first feeding pad 241, the second feeding pad 242, and the common pad 243 may be provided on the substrate 112 to supply electrical signals and/or power from the power assembly 60 to the first light-emitting diode 210a and the second light-emitting diode 210b.

The substrate 112 may be formed by alternately stacking a non-conductive insulating layer 251 and a conductive conduction layer 252.

A line or pattern through which power and/or an electrical signal pass/passes may be formed in the conduction layer 252. The conduction layer 252 may be composed of various materials having electrical conductivity. For example, the conduction layer 252 may be formed of various metal materials such as copper (Cu), tin (Sn), aluminum (Al), an alloy thereof, and the like.

A dielectric of the insulating layer 251 may insulate between the lines or patterns of the conduction layer 252. The insulating layer 251 may be composed of a dielectric for electrical insulation, for example, FR-4.

A protective layer 253 configured to prevent or suppress damage due to an external impact, damage due to a chemical action (for example, corrosion or the like and/or damage due to an optical action) may be formed on the substrate 112. The protective layer 253 may include a photo solder resist (PSR). The protective layer 253 may include a photo solder resist (PSR). The protective layer 253 may be formed by applying a liquid PSR onto the substrate 112 and then curing the liquid PSR.

The first feeding line 231 and the second feeding line 232 may be implemented by the line or pattern formed in the conduction layer 252. The first feeding line 231 and the second feeding line 232 may refer to a part of the conductive layer 252 stacked on the insulating layer 251. The first feeding pad 241, the second feeding pad 242, and the common pad 243 may also refer to a part of the conductive layer 252 stacked on the insulating layer 251.

The first feeding pad 241 may be provided at one end of the first feeding line 231. At least a portion of the first feeding pad 241 may be exposed to the outside through a first window 253a formed in the protective layer 253.

The second feeding pad 242 may be provided at one end of the second feeding line 232. At least a portion of the second feeding pad 242 may be exposed to the outside through a second window 253b formed in the protective layer 253.

The common pad 243 may be provided on the substrate 112 to be spaced apart from the first feeding pad 241 and the second feeding pad 242. At least a portion of the common pad 243 may be exposed to the outside through the first window 253a formed in the protective layer 253. At least a portion of the common pad 243 may be exposed to the outside through the second window 253b formed in the protective layer 253.

The protective layer 253 may cover the first feeding line 231 and the second feeding line 232 to block the first feeding line 231 and the second feeding line 232 from being exposed to the outside. The protective layer 253 may cover at least a portion of the first feeding pad 241, the second feeding pad 242, and the common pad 243 to block the at least a portion of the first feeding pad 241, the second feeding pad 242, and the common pad 243 from being exposed to the outside.

A first window 253a configured to expose a portion of the first feeding pad 241 to the outside may be formed in the protective layer 253 for electrical contact between the first feeding pad 241 and the first light-emitting diode 210a.

By exposing a portion of the first feeding pad 241 through the first window 253a, a conductive adhesive material 211a for electrical contact between the first feeding pad 241 and an electrode of the first light-emitting diode 210a may be applied. The conductive adhesive material 211a may be applied to the first feeding pad 241 through the first window 253a of the protective layer 253.

The anode or cathode of the first light-emitting diode 210a may come into contact with the conductive adhesive material 211a, and the first light-emitting diode 210a may be electrically connected to the first feeding pad 241 through the conductive adhesive material 211a.

The conductive adhesive material 211a may include, for example, solder having electrical conductivity. However, the present disclosure is not limited thereto, and the conductive adhesive material 211a may include electrically conductive epoxy adhesives.

A second window 253b configured to expose a portion of the second feeding pad 242 to the outside may be formed in the protective layer 253 for electrical contact between the second feeding pad 242 and the second light-emitting diode 210b. The conductive adhesive material 211b may be applied to the second feeding pad 242 through the first window 253b of the protective layer 253. Conductive adhesive material 211b may function similarly to conductive adhesive material 211a.

By exposing a portion of the second feeding pad 242 through the second window 253b, a conductive adhesive material for electrical contact between the second feeding pad 242 and an electrode of the second light-emitting diode 210b may be applied. The conductive adhesive material may be applied to the second feeding pad 242 through the second window 253b of the protective layer 253.

The anode or cathode of the second light-emitting diode 210b may come into contact with the conductive adhesive material, and the second light-emitting diode 210b may be electrically connected to the second feeding pad 242 through the conductive adhesive material.

The first window 253a may be formed in the protective layer 253 to expose a portion of the common pad 243 to the outside for electrical contact between the common pad 243 and the first light-emitting diode 210a. In addition, the second window 253b may be formed in the protective layer 253 to expose a portion of the common pad 243 to the outside for electrical contact between the common pad 243 and the second light-emitting diode 210b.

An anode or a cathode of the first light-emitting diode 210amay be electrically connected to the first feeding pad 241 through the first window 253a. A cathode or an anode of the first light-emitting diode 210a may be electrically connected to one end 243a of the common pad 243 through the first window 253a.

A cathode or an anode of the second light-emitting diode 210b may be electrically connected to the second feeding pad 242 through the second window 253b. An anode or a cathode of the second light-emitting diode 210b may be electrically connected to the other end 243b of the common pad 243 through the second window 253b.

By the above-described structure, the first light-emitting diode 210a and the second light-emitting diode 210b may be connected in series with each other. For example, the anode of the first light-emitting diode 210a may be electrically connected to the first feeding pad 241, and the cathode of the first light-emitting diode 210a may be electrically connected to the one end 243a of the common pad 243. The anode of the second light-emitting diode 210b may be electrically connected to the other end 243b of the common pad 243, and the cathode of the second light-emitting diode 210b may be electrically connected to the second feeding pad 242. In this case, current may flow from the first feeding line 231, through the first feeding pad 241, through the first light-emitting diode 210a, and to the one end 243a of the common pad 243. In addition, current may flow from the one end 243a of the common pad 243 to the other end 243b, then through the second light-emitting diode 210b, through the second feeding pad 242, and to the second feeding line 232. Since the current flows from the first feeding line 231, through the first light-emitting diode 210a and the second light-emitting diode 210b, and to the second feeding line 232, the first light-emitting diode 210a and the second light-emitting diode 210b may be connected in series.

As described above, as the first light-emitting diode 210a and the second light-emitting diode 210b are connected in series via the common pad 243, wiring on the substrate 112 may be configured relatively simply.

Since the first feeding pad 241, the first light-emitting diode 210a, the common pad 243, the second light-emitting diode 210b, and the second feeding pad 242 may be arranged within a limited area, the wiring path may be simplified and the degree of design freedom may be improved. For example, the first feeding pad 241, the first light-emitting diode 210a, the common pad 243, the second light-emitting diode 210b, and the second feeding pad 242 may be disposed within a through-hole 120a formed in a reflective sheet 120 or within an optical dome 220.

With such a configuration, the wiring path on the substrate may be simplified while maintaining or increasing the number of light-emitting diodes, thereby ensuring effective space within the substrate. By utilizing the ensured space, application to a surface-mounted structure becomes possible.

The optical dome 220 may cover the first light-emitting diode 210a and the second light-emitting diode 210b. The optical dome 220 may prevent or suppress damage to the first light-emitting diode 210a and the second light-emitting diode 210b due to an external mechanical action and/or damage to the first light-emitting diode 210a and the second light-emitting diode 210b due to a chemical action.

The optical dome 220 may have, for example, a dome shape in which a sphere is cut through a surface not including a center, or a hemispherical shape in which a sphere is cut through a surface including the center. A vertical cross-section of the optical dome 220 may be, for example, an arcuate shape or a semicircular shape.

The optical dome 220 may include a transparent resin. The optical dome 220 may include silicone or epoxy resin. According to one or more embodiments, the optical dome 220 may be formed by a molten silicone or epoxy resin being dispensed onto the first and second light-emitting diodes 210a and 210b through a nozzle, and then cured. More specifically, the optical dome 220 may be formed by dispensing a transparent resin from a nozzle directed toward the center of the first light-emitting diode 210a and a transparent resin from a nozzle directed toward the center of the second light-emitting diode 210b, and then curing the resins. In other words, the optical dome 220 may be formed by dispensing liquid resins at two points spaced apart from each other.

The optical dome 220 may be optically transparent or translucent. The light emitted from the first and second light-emitting diodes 210a and 210b may pass through the optical dome 220 to be emitted to the outside.

The optical dome 220 may refract light. For example, the light emitted from the first and second light-emitting diodes 210a and 210b may be refracted by the optical dome 220 to be distributed.

The optical dome 220 may protect the first and second light-emitting diodes 210a and 210b from an external mechanical action and/or chemical action or an electrical action, and may also distribute the light emitted from the first and second light-emitting diodes 210a and 210b.

An antistatic member 260 may be implemented by a line or a pattern formed in the conductive layer 252. The antistatic member 260 may be a part of the conductive layer 252 stacked on the insulating layer 251.

The protective layer 253 may cover the antistatic member 260 to prevent the antistatic member 260 from being exposed to the outside.

The antistatic member 260 may be provided near the optical dome 220 to protect the first and second light-emitting diodes 210a and 210b from electrostatic discharge. The antistatic member 260 may absorb electrical shock caused by electrostatic discharge generated near the optical dome 220. The antistatic member 260 may be spaced apart from the first feeding line 231, the second feeding line 232, the first feeding pad 241, the second feeding pad 242, and the common pad 243 without being in contact with the first feeding line 231, the second feeding line 232, the first feeding pad 241, the second feeding pad 242, and the common pad 243.

The optical dome 220 may protect the first and second light-emitting diodes 210a and 210b from external electrical effects. Charges generated by electrostatic discharge may not pass through the optical dome 220 and may flow along the outer surface of the optical dome 220. The charges flowing along the outer surface of the optical dome 220 may reach the first and second light-emitting diodes 210a and 210b along a boundary between the optical dome 220 and the substrate 112. The first and second light-emitting diodes 210a and 210b may be damaged by electrical shock caused by charges that penetrate along the boundary between the optical dome 220 and the substrate 112. To prevent or suppress such a charge flow, i.e., a current, the antistatic member 260 may be provided near the optical dome 220.

The antistatic member 260 may provide a path for the current generated by electrostatic discharge generated near the optical dome 220. In other words, the antistatic member 260 may guide charges such that charges generated by electrostatic discharge flow to the ground. The antistatic member 260 may be formed of the same material as the first feeding line 231 and the second feeding line 232. For example, the antistatic member 260 may be formed of various metal materials such as copper (Cu), tin (Sn), aluminum (Al), or an alloy thereof.

The protective layer 253 may cover the antistatic member 260 to block the antistatic member 260 from being exposed to the outside. The protective layer 253 may include a window for forming an antistatic pad in which charges caused by electrostatic discharge are captured. A part of the antistatic member 260 may be exposed to the outside by the window of the protective layer 253. The part of the antistatic member 260 exposed to the outside may form the antistatic pad.

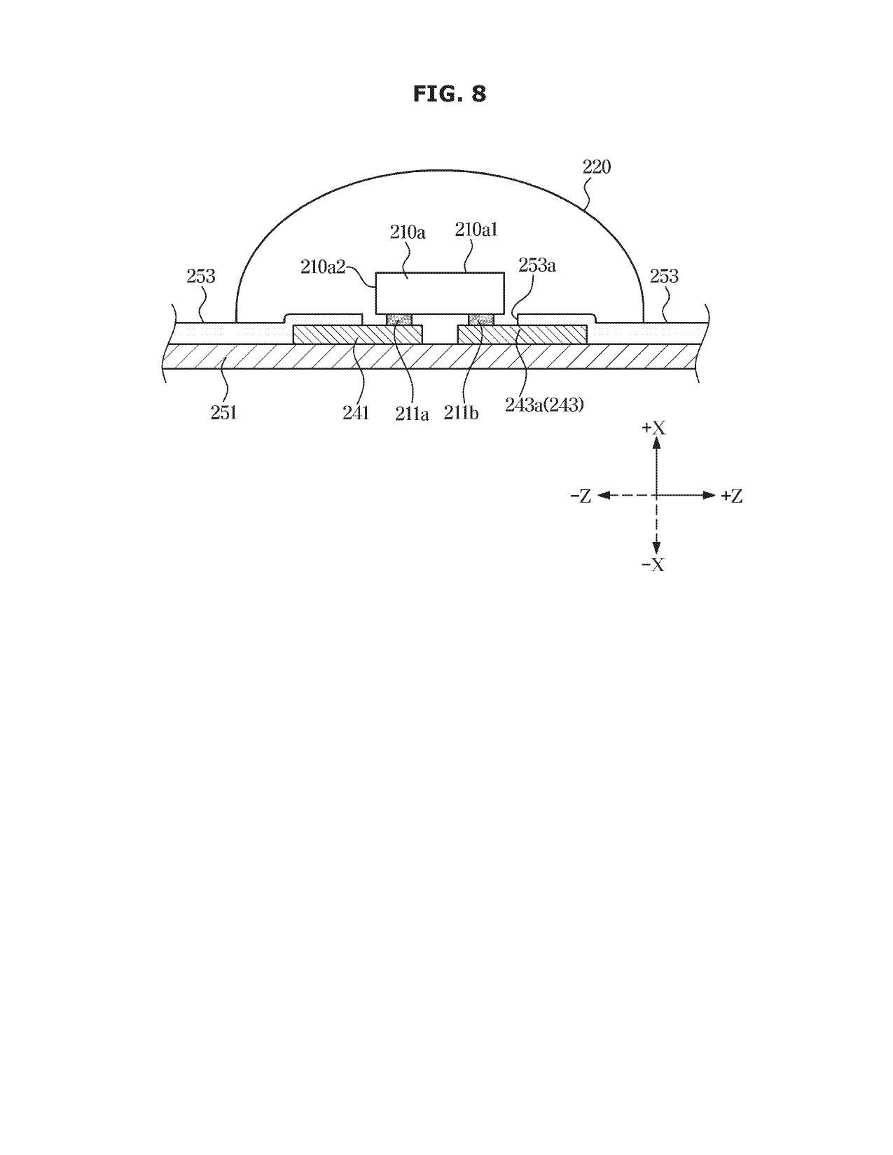

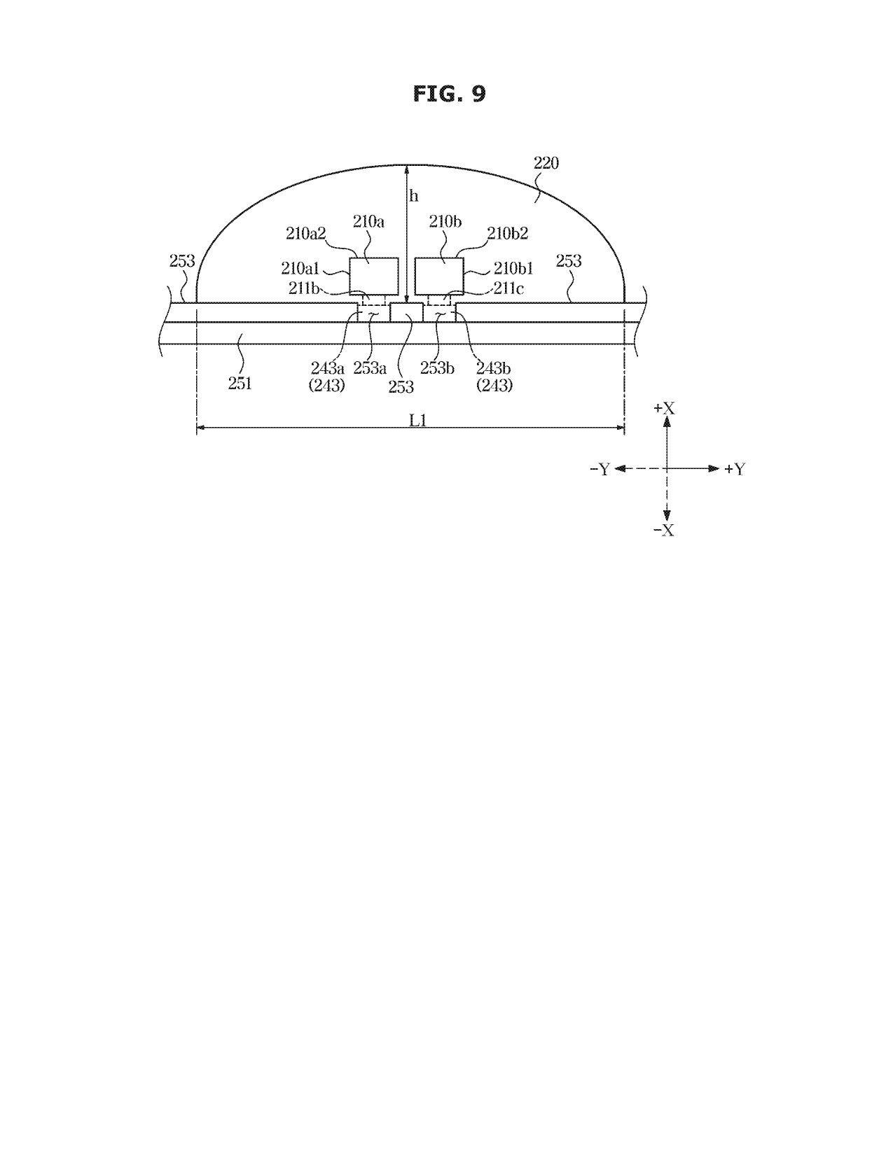

FIG. 8 is a cross-sectional view taken along line A-A’ of FIG. 5. FIG. 9 is a cross-sectional view taken along line B-B’ of FIG. 5.

Referring to FIG. 7, the first light-emitting diode 210a has a long side 210a1 and a short side 210a2. The second light-emitting diode 210b has a long side 210b1 and a short side 210b2.

According to one or more embodiments, the long side 210a1 of the first light-emitting diode 210aand the long side 210b1 of the second light-emitting diode 210b may be arranged parallel to each other. In addition, the long side 210a1 of the first light-emitting diode 210a and the long side 210b1 of the second light-emitting diode 210b may be spaced apart in a first direction. The first direction may indicate the Y direction.

According to one or more embodiments, the common pad 243 may extend in the first direction to connect one end of the first light-emitting diode 210a and one end of the second light-emitting diode 210b. In other words, the common pad 243 may extend along the Y direction. Accordingly, the one end 243a and the other end 243b of the common pad 243 may be spaced apart in the first direction.

The short side 210a2 of the first light-emitting diode 210a and the short side 210b2 of the second light-emitting diode 210b may be arranged substantially on the same straight line. Here, the expression “substantially on the same straight line” encompasses not only the case where they are exactly positioned on a straight line, but also forms aligned in a similar manner.

Referring to FIG. 7, the bottom surface of the optical dome 220 according to the present disclosure may be formed with a length in the first direction and a length in a second direction perpendicular to the first direction being different from each other. The length in the first direction may indicate the length in the Y direction, and the length in the second direction may indicate the length in the Z direction. Specifically, the bottom surface of the optical dome 220 may be formed such that the length in the first direction is greater than the length in the second direction. Hereinafter, the length of the bottom surface of the optical dome 220 in the first direction is referred to as a major axis, and the length of the bottom surface of the optical dome 220 in the second direction is referred to as a minor axis. The major axis may be arranged parallel to the short sides of the first and second light-emitting diodes 210a and 210b. The minor axis may be arranged parallel to the long sides of the first and second light-emitting diodes 210a and 210b.

Referring to FIGS. 7 to 9, the distance by which the long side 210a1 of the first light-emitting diode 210a and the long side 210b1 of the second light-emitting diode 210b are spaced apart in the first direction is defined as d. The major axis of the optical dome 220 is defined as L1, and the minor axis of the optical dome 220 is defined as L2. The maximum distance between the optical dome 220 and the substrate 112 is defined as the height h of the optical dome 220. The height h of the optical dome 220 may indicate the maximum distance in the X direction between the optical dome 220 and the substrate 112.

The first and second light-emitting diodes 210a and 210b may be configured such that the amount of light output in the direction of the long sides is greater than the amount of light output in the direction of the short sides. In other words, the amount of light output in the Y direction may be greater than the amount of light output in the Z direction. This is because the light output path in the direction of the long side of the first and second light-emitting diodes 210a and 210b is shorter than the light output path in the direction of the short side, which results in relatively reduced light loss. Due to such optical characteristics of the first and second light-emitting diodes 210a and 210b, bright spots or dark spots may be visible in the backlight unit 100. For example, a phenomenon in which dark spots are visible in a line form between a plurality of light sources 111 may occur. Such degradation in light uniformity is referred to as “mura.”

According to one or more embodiments, in order to reduce or eliminate the occurrence of mura in the backlight unit 100, the ratio of the minor axis L2 to the major axis L1 of the optical dome 220 may be 0.8 or more and 0.9 or less. This may be expressed as 0.8 ≤ L2/L1 ≤ 0.9.

According to one or more embodiments, in order to reduce or eliminate the occurrence of mura in the backlight unit 100, the distance d by which the long side 210a1 of the first light-emitting diode 210a and the long side 210b1 of the second light-emitting diode 210b are spaced apart in the first direction may be between 250 µm and 350 µm.

According to one or more embodiments, in order to reduce or eliminate the occurrence of mura in the backlight unit 100, the ratio of the height h of the optical dome 220 to the major axis L1 of the optical dome 220 may be between 0.245 and 0.305. This may be expressed as 0.245 ≤ h/L1 ≤ 0.305.

According to one or more embodiments, in order to reduce or eliminate the occurrence of mura in the backlight unit 100, the ratio of the height h of the optical dome 220 to the minor axis L2 of the optical dome 220 may satisfy a range of 0.245(1 + d/L2) to 0.305(1 + d/L2). In other words, the following relational expression may be satisfied:

0.245(1 + d/L2) ≤ h/L2 ≤ 0.305(1 + d/L2).

A display apparatus according to an embodiment includes: a display panel and a backlight unit configured to provide light to the display panel. The backlight unit includes: a substrate including a first feeding pad, a second feeding pad, and a common pad; a first light-emitting diode configured to be connected to the first feeding pad and the common pad; a second light-emitting diode spaced apart from the first light-emitting diode in a first direction and configured to be connected to the second feeding pad and the common pad; and an optical dome configured to cover the first light-emitting diode and the second light-emitting diode. A bottom surface of the optical dome is formed such that a length in the first direction and a length in a second direction perpendicular to the first direction are different from each other.

The first feeding pad may be configured to be connected to an anode of the first light-emitting diode.

The second feeding pad may be configured to be connected to a cathode of the second light-emitting diode.

The common pad may be configured to be connected to a cathode of the first light-emitting diode and an anode of the second light-emitting diode.

The cathode of the first light-emitting diode and the anode of the second light-emitting diode may be spaced apart in the first direction.

The common pad extends in the first direction to be connected to the cathode of the first light-emitting diode and the anode of the second light-emitting diode.

The bottom surface of the optical dome may be formed such that the length in the first direction is longer than the length in the second direction.

A long side of the first light-emitting diode and a long side of the second light-emitting diode may be disposed parallel to each other and spaced apart in the first direction.

A major axis, which is a maximum length of the optical dome in the first direction, may be disposed parallel to short sides of the first light-emitting diode and the second light-emitting diode.

A minor axis, which is a maximum length of the optical dome in the second direction, may be disposed parallel to long sides of the first light-emitting diode and the second light-emitting diode.

A ratio of the minor axis to the major axis may be 0.8 or more and 0.9 or less.

A separation distance in the first direction between the long side of the first light-emitting diode and the long side of the second light-emitting diode may be 250 μm or more and 350 μm or less.

A maximum separation distance between the substrate and the optical dome in a third direction perpendicular to the first direction and the second direction may be a height of the optical dome.

A ratio of the height to the major axis may be 0.245 or more and 0.305 or less.

A maximum separation distance between the substrate and the optical dome in a third direction perpendicular to the first direction and the second direction may be h, a separation distance in the first direction between the long side of the first light-emitting diode and the long side of the second light-emitting diode may be d, a length of the major axis may be L1, a length of the minor axis may be L2; and 0.245(1 + d/L2) ≤ h/L2 ≤ 0.305(1 + d/L2).

The optical dome may be formed by a liquid resin dispensed at two points spaced apart in the first direction.

The first light-emitting diode and the second light-emitting diode may be connected in series.

The display apparatus may further include: a reflective sheet configured to cover the substrate and having a plurality of holes formed therein.

The first light-emitting diode, the second light-emitting diode, and the optical dome may be provided inside each of the plurality of holes.

The first feeding pad may be connected to an end of a first feeding line extending from outside to inside of each of the plurality of holes.

The second feeding pad may be connected to an end of a second feeding line extending from outside to inside of each of the plurality of holes.

Both ends of the common pad may be provided inside each of the plurality of holes.

The display apparatus may further include a protective layer provided to cover the substrate between the substrate and the reflective sheet.

The protective layer may include: a first window configured to expose at least a portion of the first feeding pad and a first portion of the common pad; and a second window configured to expose at least a portion of the second feeding pad and a second portion of the common pad.

According to the spirit of the present disclosure, a backlight unit and a display apparatus that enhance visual quality by improving light uniformity and reducing mura can be provided.

According to the spirit of the present disclosure, a backlight unit and a display apparatus having enhanced luminance can be provided.

According to the spirit of the present disclosure, a backlight unit and a display apparatus including an optical dome designed to cover a plurality of light-emitting diodes can be provided.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A display apparatus comprising:
a display panel; and
a backlight unit configured to provide light to the display panel;
wherein the backlight unit comprises:
a substrate comprising a first feeding pad, a second feeding pad, and a common pad;
a first light-emitting diode connected to the first feeding pad and the common pad;
a second light-emitting diode spaced apart from the first light-emitting diode in a first direction and connected to the second feeding pad and the common pad; and
an optical dome on the first light-emitting diode and the second light-emitting diode, and
wherein a length of a bottom surface of the optical dome in the first direction is different from a length of the bottom surface in a second direction perpendicular to the first direction.

2. The display apparatus of claim 1, wherein the first feeding pad is connected to an anode of the first light-emitting diode,
wherein the second feeding pad is connected to a cathode of the second light-emitting diode, and
wherein the common pad is connected to a cathode of the first light-emitting diode and an anode of the second light-emitting diode.

3. The display apparatus of claim 2, wherein the cathode of the first light-emitting diode and the anode of the second light-emitting diode are spaced apart in the first direction, and
wherein the common pad extends in the first direction and is connected to the cathode of the first light-emitting diode and the anode of the second light-emitting diode.

4. The display apparatus of claim 1, wherein the length of the bottom surface in the first direction is longer than the length of the bottom surface in the second direction.

5. The display apparatus of claim 1, wherein a long side of the first light-emitting diode and a long side of the second light-emitting diode are parallel to each other and are spaced apart in the first direction,
wherein a maximum length of the optical dome in the first direction is a major axis of the optical dome,
wherein a maximum length of the optical dome in the second direction is a minor axis of the optical dome,
wherein the major axis is parallel to a short side of the first light-emitting diode and a short side of the second light-emitting diode, and
wherein the minor axis is parallel to a long side of the first light-emitting diode and a long side of the second light-emitting diode.

6. The display apparatus of claim 5, wherein a ratio of the minor axis to the major axis is greater than or equal to 0.8 and is less than or equal to 0.9.

7. The display apparatus of claim 5, wherein a separation distance in the first direction between the long side of the first light-emitting diode and the long side of the second light-emitting diode is greater than or equal to 250 μm and is less than or equal to 350 μm.

8. The display apparatus of claim 5, wherein a maximum separation distance between the substrate and the optical dome in a third direction perpendicular to the first direction and the second direction is a height of the optical dome, and
wherein a ratio of the height to the major axis is greater than or equal to 0.245 and is less than or equal to 0.305.

9. The display apparatus of claim 5, wherein a maximum separation distance between the substrate and the optical dome in a third direction perpendicular to the first direction and the second direction is h,
wherein a separation distance in the first direction between the long side of the first light-emitting diode and the long side of the second light-emitting diode is d,
wherein a length of the major axis is L1,
wherein a length of the minor axis is L2, and
wherein 0.245(1 + d/L2) ≤ h/L2 ≤ 0.305( 1 + d/L2).

10. A method of manufacturing the display apparatus of claim 1, the method comprising: forming the optical dome by dispensing a liquid resin at two points spaced apart in the first direction.

11. The display apparatus of claim 1, wherein the first light-emitting diode and the second light-emitting diode are connected in series.

12. The display apparatus of claim 1, further comprising:
a reflective sheet on the substrate, the reflective sheet comprising a plurality of holes,
wherein the first light-emitting diode, the second light-emitting diode, and the optical dome are inside a hole among the plurality of holes.

13. The display apparatus of claim 12, wherein the first feeding pad is connected to an end of a first feeding line extending from outside to inside the hole,
wherein the second feeding pad is connected to an end of a second feeding line extending from outside to inside the hole, and
wherein both ends of the common pad are inside the hole.

14. The display apparatus of claim 12, further comprising:
a protective layer between the substrate and the reflective sheet,
wherein the protective layer is on the substrate, and
wherein the protective layer comprises:
a first window exposing at least a portion of the first feeding pad and a first portion of the common pad; and
a second window exposing at least a portion of the second feeding pad and a second portion of the common pad.

15. A display apparatus comprising:
a display panel; and
a backlight unit configured to provide light to the display panel;
wherein the backlight unit comprises:
a substrate; and
a plurality of light sources on the substrate,
wherein each light source of the plurality of light sources comprises:
a first feeding pad, a second feeding pad, and a common pad;
a first light-emitting diode connected to the first feeding pad and the common pad;
a second light-emitting diode spaced apart from the first light-emitting diode in a first direction and connected to the second feeding pad and the common pad; and
an optical dome on the first light-emitting diode and the second light-emitting diode,
wherein a length in the first direction of a bottom surface of the optical dome of each of the plurality of light sources is different from a length in a second direction of the bottom surface of the optical dome of each of the plurality of light sources, and
wherein the second direction is perpendicular to the first direction.

16. The display apparatus of claim 15, further comprising:
a reflective sheet on the substrate, the reflective sheet comprising a plurality of holes,
wherein each of the plurality of light sources is inside a respective hole of the plurality of holes.

17. The display apparatus of claim 16, wherein, for each of the plurality of light sources:
the first feeding pad is connected to an end of a first feeding line extending from outside to inside of the hole in which the light source is located, among the plurality of holes,
the second feeding pad is connected to an end of a second feeding line extending from outside to inside of the hole in which the light source is located, among the plurality of holes, and
both ends of the common pad are inside of the hole in which the light source is located, among the plurality of holes.

18. The display apparatus of claim 16, further comprising a protective layer between the substrate and the reflective sheet,
wherein the protective layer covers the substrate, and
wherein the protective layer comprises:
a plurality of first windows each exposing at least a portion of the first feeding pad and a first portion of the common pad of a respective light source among the plurality of light sources; and
a plurality of second windows each exposing at least a portion of the second feeding pad and a second portion of the common pad of a respective light source among the plurality of light sources.

19. A backlight unit configured to provide light to a display panel, the backlight unit comprising:
a first light-emitting diode;
a second light-emitting diode spaced apart from the first light-emitting diode in a first direction; and
an optical dome on the first light-emitting diode and the second light-emitting diode,
wherein a length of a bottom surface of the optical dome in the first direction is different from a length of the bottom surface in a second direction perpendicular to the first direction.

20. The backlight unit of claim 19, wherein a long side of the first light-emitting diode and a long side of the second light-emitting diode are parallel to each other and are spaced apart in the first direction,
wherein a maximum length of the optical dome in the first direction is a major axis of the optical dome,
wherein a maximum length of the optical dome in the second direction is a minor axis of the optical dome,
wherein the major axis is parallel to a short side of the first light-emitting diode and a short side of the second light-emitting diode, and
wherein the minor axis is parallel to a long side of the first light-emitting diode and a long side of the second light-emitting diode.
